(19) United States
(12) Patent Application Publication
(10) Pub. No.: US 2007/0295917 A1
(43) Pub. Date: Dec. 27, 2007

(54) Single excitation wavelength fluorescent detection system

(75) Inventor: Howard G. King, Berkeley, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/044,390

(22) Filed: Jan. 26, 2005

Related U.S. Application Data
(60) Provisional application No. 60/539,473, filed on Jan. 26, 2004.

(51) Int. Cl. G01J 1/58

(52) U.S. Cl. 250/458.1

(57) ABSTRACT

The present application relates to an apparatus and method for fluorescent detection with a single-wavelength excitation.

### CROSS-REFERENCE TO RELATED APPLICATIONS

This application claims a priority benefit under 35 U.S.C. § 119(e) from U.S. Patent Application Ser. No. 60/539,473 filed Jan. 26, 2004, which is incorporated herein by reference.

### FIELD

The present application relates to an apparatus and method for fluorescent detection from a single excitation wavelength.

### INTRODUCTION

Detection of dye-labels from biological reactions, for example, a sequencing reaction, polymerase chain reaction (PCR), or a microarray hybridization reaction, can present a number of challenges for detection of dye-labeled primers or dye-labeled nucleotides by a fluorescent detection system. Fluorescent dyes can be characterized spectrally by an excitation efficiency profile and/or an emission profile. When multiple dyes are used in a fluorescent detection system, it can be desirable to maximize the separation between peaks of the respective emission profiles to facilitate spectral detection. The fixed shift between the peak of the excitation and peak of the emission profiles is referred to as Stoke's shift. The Stoke's shift varies from 15-35 nanometers in certain dyes. As a result of the desire to maximize the emission profile separation, the excitation efficiency for dyes within a dye set can vary greatly.

Energy transfer dyes can absorb excitation energy by one or more dyes and transfer the emission energy to a variety of emission dyes providing desirable excitation efficiency. This offers a solution to the excitation efficiency variability. However, some biological instruments are used to run a variety of reactions using various dye sets. Some instruments use dye sets which include both simple fluorescent dyes and energy transfer dyes. Multiple-wavelength excitation can be used to provide desirable excitation efficiency across all dye sets, such as providing multiple excitation light sources or using multi-wavelength excitation light sources. It is desirable to provide a fluorescent detection system with single-wavelength excitation for a broad range of dyes that can include both simple fluorescent dyes and energy transfer dyes.

### SUMMARY

According to various embodiments, the present teachings can provide a system for fluorescent detection, the system including a single-wavelength excitation light source, wherein the wavelength is from 480 nanometers to 520 nanometers.

According to various embodiments, the present teachings can provide a system for fluorescent detection, the system including a single-wavelength excitation light source adapted to provide excitation to simple fluorescent dyes and energy transfer dyes, wherein the wavelength of excitation provides an effective Stoke's shift of at least 10 nanometers for simple fluorescent dyes and energy transfer dyes.

According to various embodiments, the present teachings can provide a method for fluorescent detection, the method including providing a single-wavelength excitation light source, wherein the wavelength is from 480 nanometers to 520 nanometers, exciting a plurality of dyes, wherein the dyes comprise simple fluorescent dyes and energy transfer dyes, and detecting fluorescent light from the plurality of dyes to provide information concerning a biological reaction.

### BRIEF DESCRIPTION OF THE DRAWINGS

FIG. 1 illustrates a perspective view of a fluorescent detection system according to various embodiments;

FIG. 2 illustrates a chart of dye excitation average and weakest dye strength according to various embodiments;

FIGS. 3-5 illustrate charts of dye excitation efficiency according to various embodiments;

FIG. 6 illustrates a chart of fluorescent excitation according to various embodiments;

FIG. 7 illustrates a chart of fluorescent emission according to various embodiments;

FIGS. 8-9 illustrate charts of excitation spectra according to various embodiments;

FIG. 10 illustrates a chart of peak wavelengths for excitation and emission according to various embodiments;

FIG. 11 illustrates chart of Stoke's shift according to various embodiments; and

FIG. 12 illustrates a chart of power output of a multi-wavelength argon-ion laser for different wavelengths according to various embodiments;

### DESCRIPTION OF VARIOUS EMBODIMENTS

In this application, the use of the singular includes the plural unless specifically stated otherwise. In this application, the use of “or” means “and/or” unless stated otherwise. Furthermore, the use of the term “including”, as well as other forms, such as “includes” and “included”, is not limiting. Also, terms such as “element” or “component” encompass both elements and components comprising one unit and elements and components that comprise more than one subunit unless specifically stated otherwise. Wherever possible, the same reference numbers will be used throughout the drawings to refer to the same or like parts.

The section headings used herein are for organizational purposes only, and are not to be construed as limiting the subject matter described. All documents cited in this application, including, but not limited to patents, patent applications, articles, books, and treatises, are expressly incorporated by reference in their entirety for any purpose.

The term “excitation light source” as used herein refers to a source of irradiance that can provide excitation that results in fluorescent emission. Light sources can include, but are not limited to, lasers, solid state laser, laser diode, micro-wire laser, diode solid state lasers (DSSL), vertical-cavity surface-emitting lasers (VCSEL), LEDs, phosphor coated LEDs, organic LEDs (OLED), thin-film electroluminescent devices (TFELD), phosphorescent OLEDs (PHOLED), inorganic-organic LEDs, LEDs using quantum dot technology, LED arrays. Light sources can have high irradiance, such as lasers, or low irradiance, such as LEDs. The different types of LEDs mentioned above can have a medium to high irradiance.

The term “simple fluorescent dye” as used herein refers to a fluorescent dye that is not an energy transfer dye, such as fluoresceins, rhodamines, and d-rhodamines. Other examples of simple fluorescent dyes can include, but are not limited to, fluorescent molecules, including, but not limited to, fluoresceins, which include, but are not limited to, 6-carboxyfluorescein, 2′,4′,1,4,-tetrachlorofluorescein, and 2′,4′,5′,7′,1,4-hexachlorofluorescein (see, e.g., U.S. Pat. Nos. 5,188,934; 6,008,379; and 6,020,481); rhodamines (see, e.g., U.S. Pat. Nos. 5,366,860; 5,847,162; 5,936,087; 6,051,719; and 6,191,278); benzophenoxazines (see, e.g., U.S. Pat. No. 6,140,500); energy-transfer fluorescent dyes, which comprise pairs of donors and acceptors (see, e.g., U.S. Pat. Nos. 5,863,727; 5,800,996; and 5,945,526); and cyanines (see, e.g., WO 97/45539); as well as any other fluorescent moiety capable of generating a detectable signal. Other exemplary simple fluorescent dyes include, but are not limited to, luminescent molecules and molecules that can be involved in luminescent reactions, such as luciferin-luciferase reactions, as a non-limiting example. Labels also include, but are not limited to, chemiluminescent and electroluminescent molecules and reactions. In certain embodiments, chemiluminescent labels interact with a chemiluminescent substrate to produce a chemiluminescent signal. In certain embodiments, chemiluminescent labels bind to a molecule or complex that interacts with a chemiluminescent substrate to produce a chemiluminescent signal. As a non-limiting example, chemiluminescent labels may be exposed to film. Development of the film indicates whether or not the chemiluminescent labels are present in the sample and/or the quantity of the chemiluminescent labels in the sample.

The term “energy transfer dyes” as used herein refers to fluorescent dyes that use one or more dyes to absorb excitation energy, such as FAM, and can transfer energy to one or more emission dyes, such as TET, VIC, HEX, NED, TAMRA, ROX, and PAT, positioned on the same dye molecule. Energy transfer dyes can also be characterized as including pairs of donors and acceptors (see, e.g., U.S. Pat. Nos. 5,863,727; 5,800,996; and 5,945,526) sold as Big Dye Terminators®, Applied Biosystems (Foster City, Calif.). Other exemplary energy transfer dyes include, but are not limited to, donor-acceptor interactions, in which a donor molecule emits energy that is detected by an acceptor molecule. The acceptor molecule then emits a detectable signal. Other exemplary energy transfer dyes include, but are not limited to, a molecule that interacts with a second molecule or other member of a set of molecules to provide a detectable signal. The signal may be provided by either the first molecule or the second molecule, e.g., FRET (Fluorescent Resonance Energy Transfer), or set of molecules. Labels include, but are not limited to, light-emitting or light-absorbing compounds which generate or quench a detectable fluorescent, chemiluminescent, or bioluminescent signal (see, e.g., Kricka, L. in Nonisotopic DNA Probe Techniques (1992), Academic Press, San Diego, pp. 3-28 Other exemplary energy transfer dyes include, but are not limited to, quantum dots. “Quantum dots” refer to semiconductor nanocrystalline compounds capable of emitting a second energy in response to exposure to a first energy. Typically, the energy emitted by a single quantum dot always has the same predictable wavelength. Exemplary semiconductor nanocrystalline compounds include, but are not limited to, crystals of CdSe, CdS, and ZnS. Suitable quantum dots according to certain embodiments are described, e.g., in U.S. Pat. Nos. 5,990,479 and 6,207,392 B1, and in “Quantum-dot-tagged microbeads for multiplexed optical coding of biomolecules,” Han et al., Nature Biotechnology, 19:631-635 (2001).

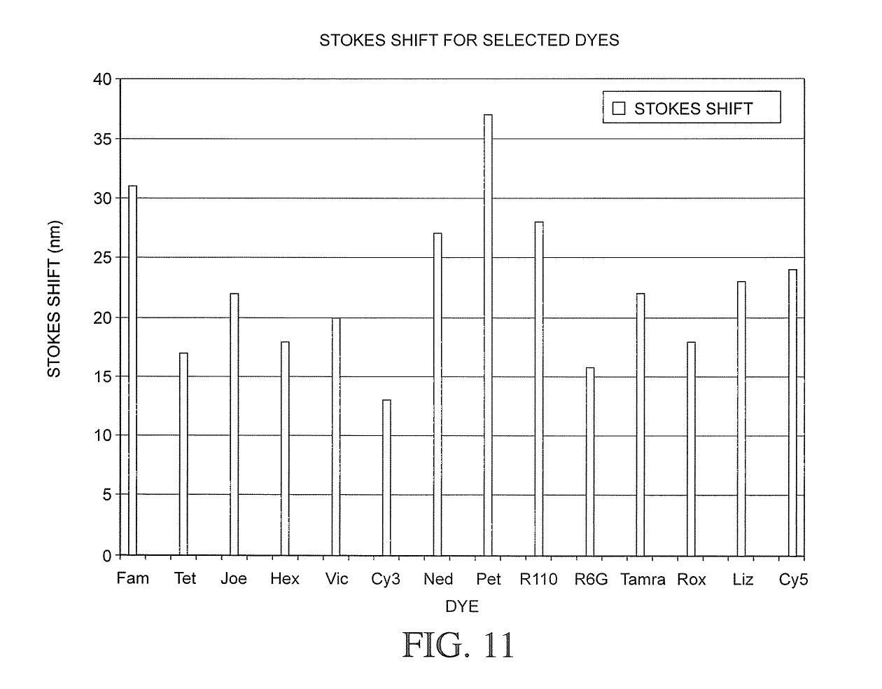

The term “effective Stoke's shift” as used herein refers to the fixed shift between the peak of the excitation and peak of the emission profiles for both simple fluorescent dyes and energy transfer dyes where the shift is between the peak of the excitation profile of the absorbing dye and the peak of the emission profile of the emission dye. As illustrated in FIG. 11, the minimum effective Stoke's shift for desirable detection is 10 nanometers.

The term “detector” as used herein refers to any component, portion thereof, or system of components that can detect light including a charged coupled device (CCD), back-side thin-cooled CCD, front-side illuminated CCD, a CCD array, a photodiode, a photodiode array, a photo-multiplier tube (PMT), a PMT array, complimentary metal-oxide semiconductor (CMOS) sensors, CMOS arrays, a charge-injection device (CID), CID arrays, etc. The detector can be adapted to relay information to a data collection device for storage, correlation, and/or manipulation of data, for example, a computer, or other signal processing system.

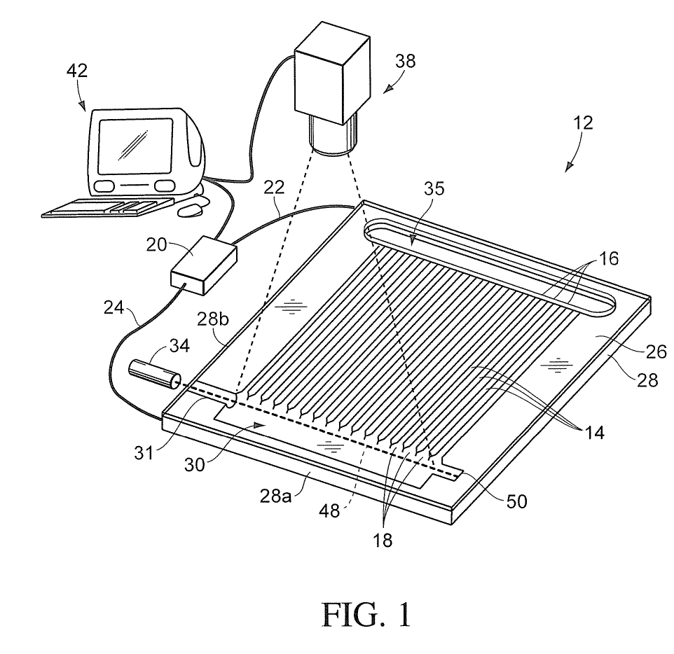

According to various embodiments, as illustrated in FIG. 1, a fluorescent detection system can include an excitation light source. As illustrated, the excitation light source in this embodiment is a laser. The fluorescent detection system 12 can include laser 34 that can be positioned perpendicular to capillaries 14 and detector 38 such that laser beam 48 intersects the outlets 18 in detection chamber 30. The electrophoresis is conducted between reservoir 35 and reservoir 31 by power source 20 that contact the reservoirs via electrodes 22 and 24 respectively. The computer 42 is coupled to the detector 38 and power supply 20. Plates 26 and 28 with capillaries 14 form the capillary electrophoresis assembly.

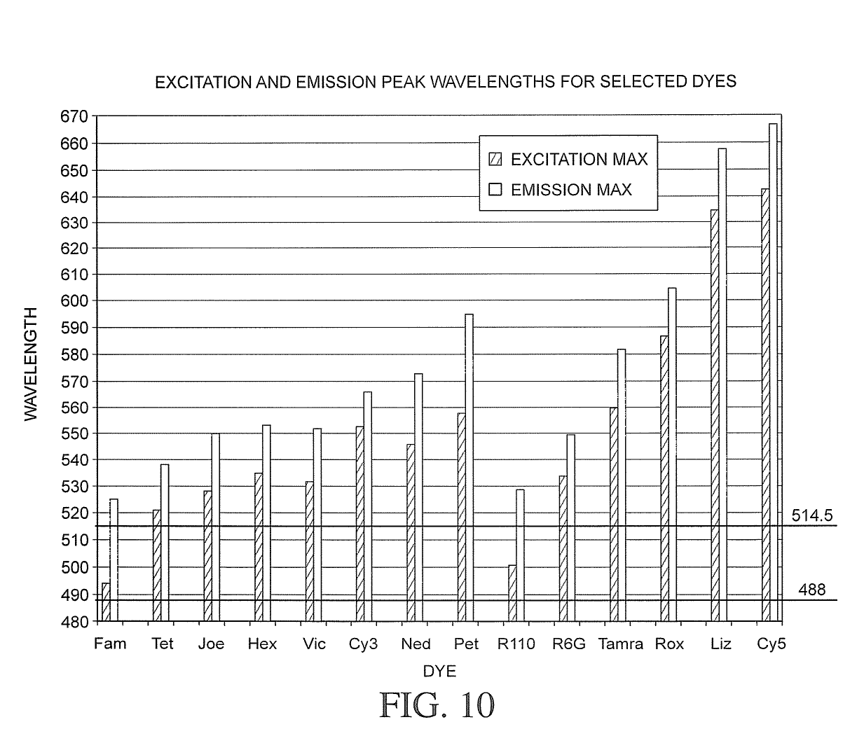

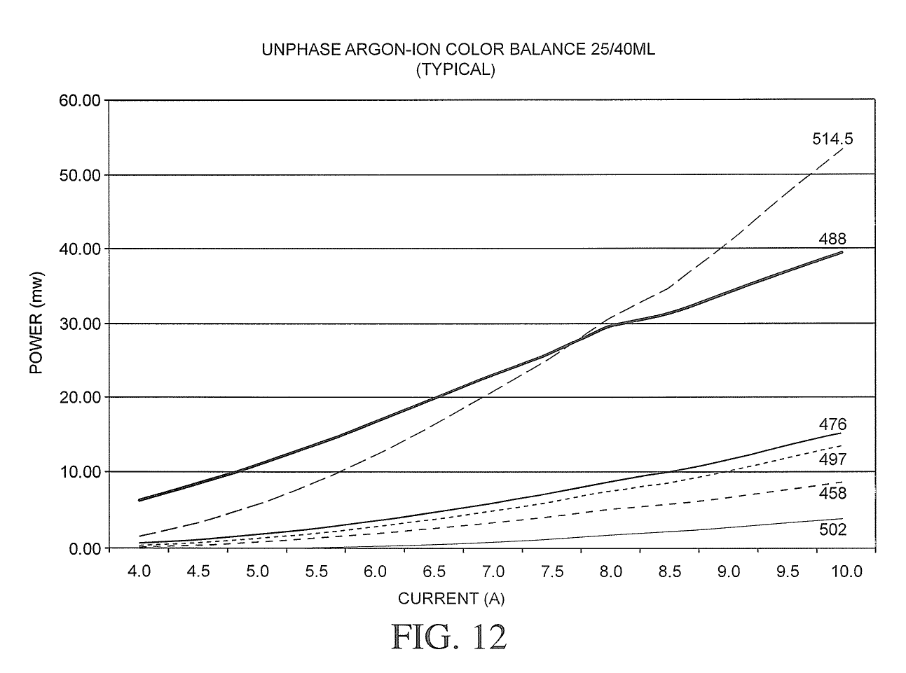

According to various embodiments, an Argon-ion laser can emit multiple-wavelengths of excitation light. As illustrated in FIG. 12, the Argon-ion laser can emit primary wavelengths of 488 nanometers and 514.5 nanometers, and secondary wavelengths of 476 nanometers, 497 nanometers, 458 nanometers and 502 nanometers, each descending in brightness. As illustrated in FIG. 10, the dual primary excitation wavelengths provide wavelengths that intersect the ranges of excitation wavelengths for the simple fluorescent dyes and energy transfer dyes shown on the chart.

According to various embodiments, solid state lasers can provide advantages over gas lasers, such as the Argon-ion laser. The advantages include compact size, reliability, cost-effectiveness, and noise reduction.

According to various embodiments, a single-wavelength solid state laser that can provide a single-wavelength excitation in the range of 480 nanometers to 520 nanometers can provide excitation to simple fluorescent dyes and energy transfer dyes. According to various embodiments, a single-wavelength excitation in the range of 500 nanometers to 515 nanometers can provide excitation to simple fluorescent dyes and energy transfer dyes. According to various embodiments, a single-wavelength excitation in the range of 505 nanometers to 510 nanometers can provide excitation to simple fluorescent dyes and energy transfer dyes. According to various embodiments, a single-wavelength excitation in the range of 488 nanometers to 490 nanometers can provide excitation to simple fluorescent dyes and energy transfer dyes. According to various embodiments, a solid state laser can be used in sequencing reaction detection, PCR detection, and microarray hybridization detection. According to various embodiments, the laser provides a small diameter beam of light over an extended distance suited for capillary electrophoresis applications as illustrated in FIG. 1.

According to various embodiments, solid state lasers can provide a wavelength in the range of the present teachings with direct diode lasers that include non-linear crystals to double the frequency and thereby reduce the wavelength by half. According to various embodiments, solid state lasers can provide a wavelength in the range of the present teachings without non-linear crystals. (See, e.g., Wahl, E., Optical Performance Comparison of Argon-Ion and Solid-State Cyan Lasers, Optics & Photonics News, pp. 36-42, November 2003).

According to various embodiments, other excitation light sources can provide single-wavelength excitation in the range of the present teachings.

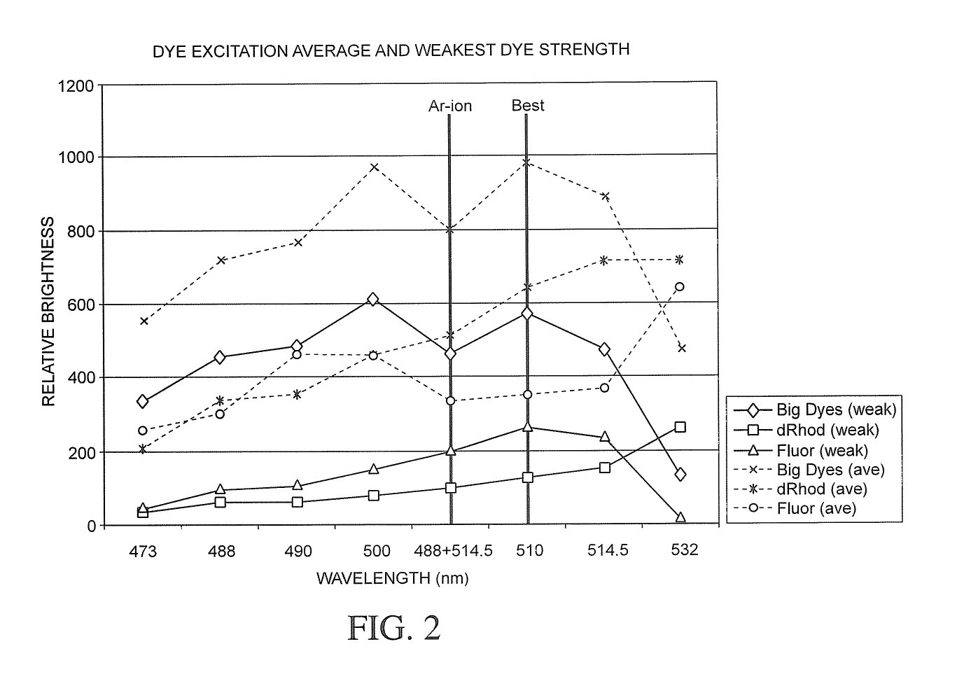

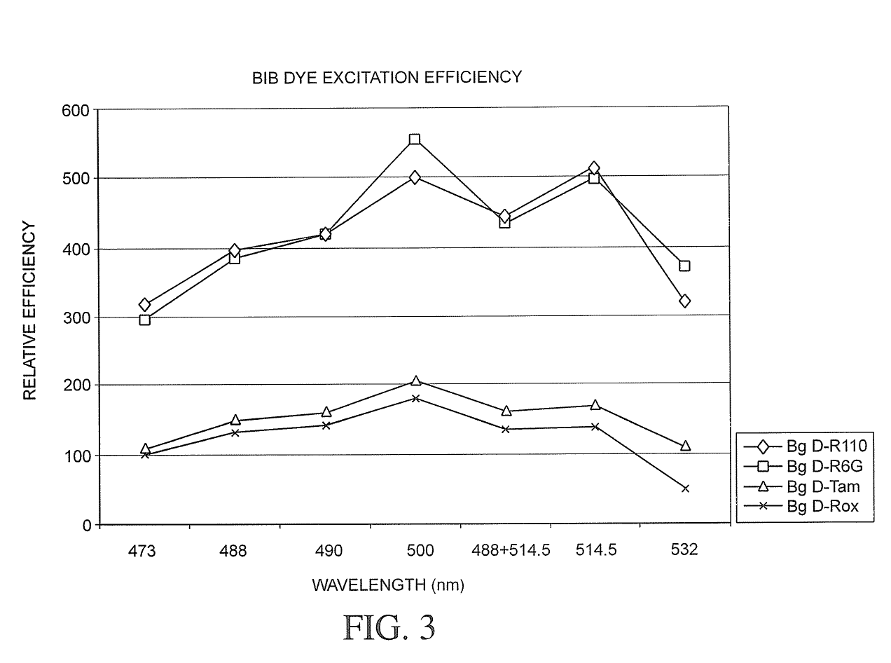

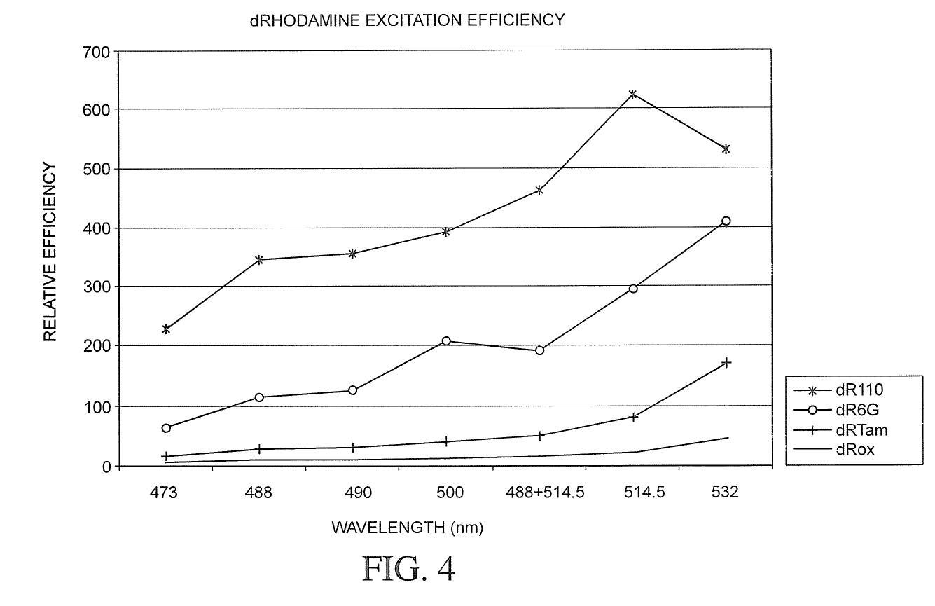

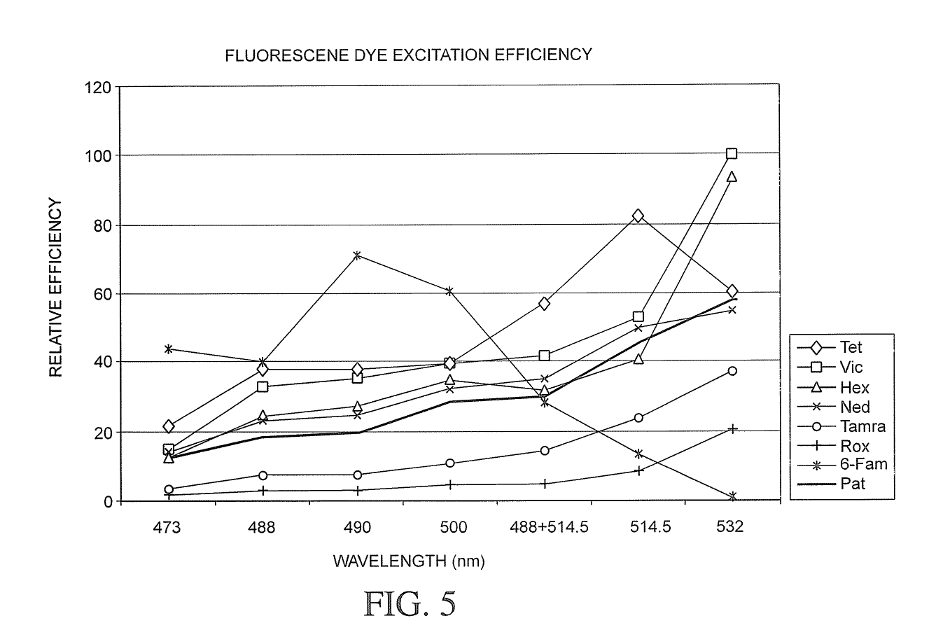

According to various embodiments, FIGS. 2-5 show the relative excitation efficiency within various dye sets, excited at various wavelengths. They demonstrate how the average and worst case dye efficiencies change with different excitation wavelengths. While various different wavelengths within the range being discussed have some potential to excite all dyes, it is clear that some wavelengths within this range perform better than others with regards to average or worst case excitation efficiency.

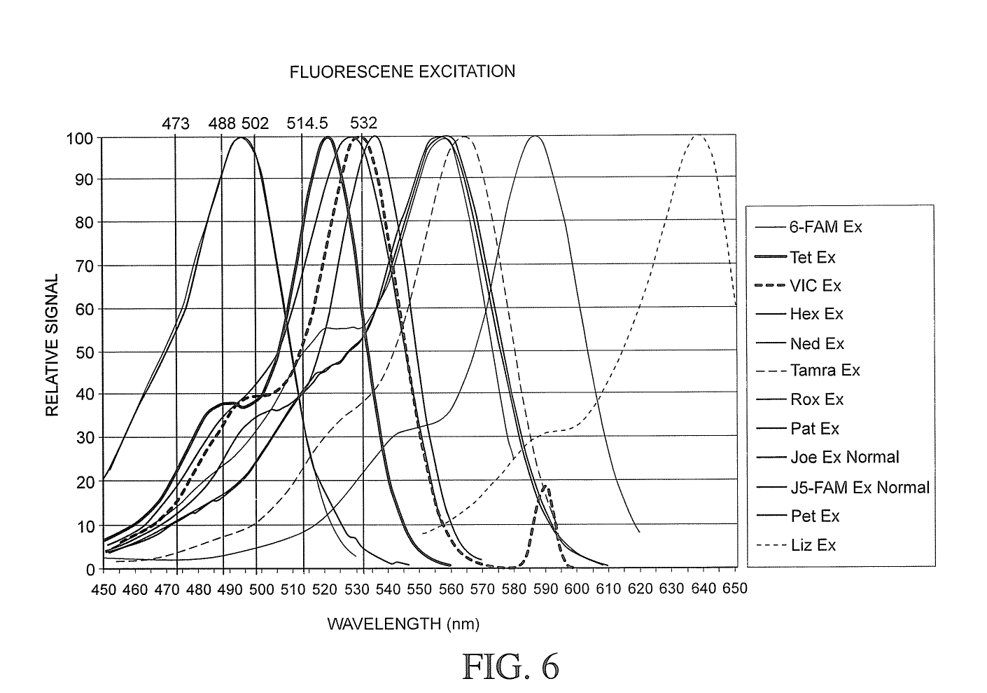

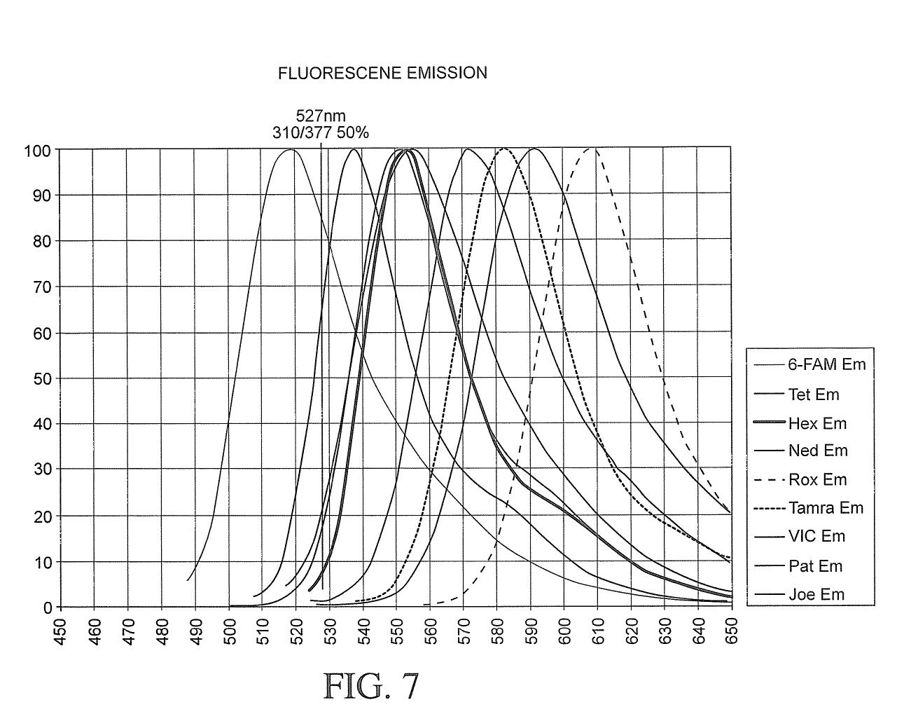

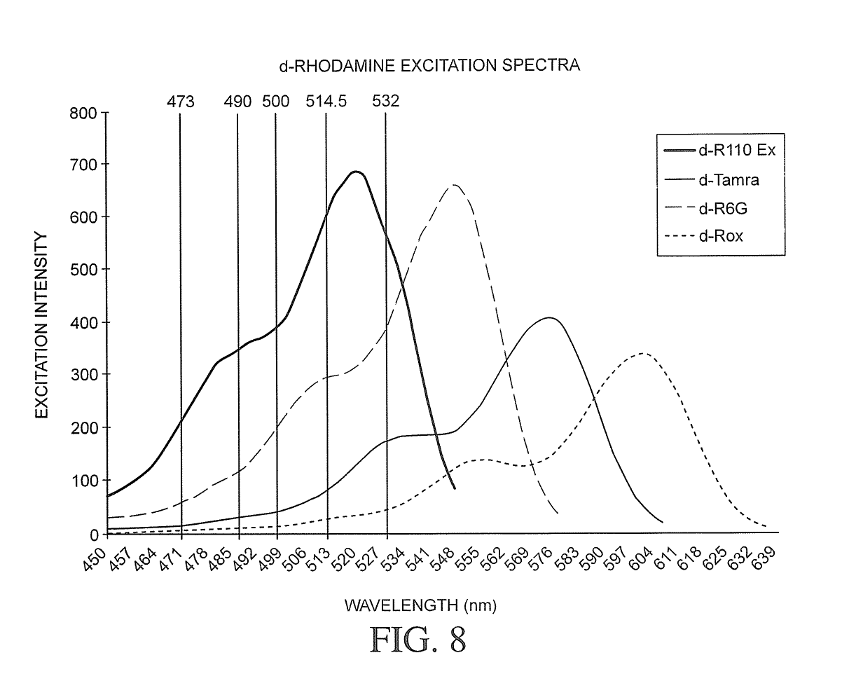

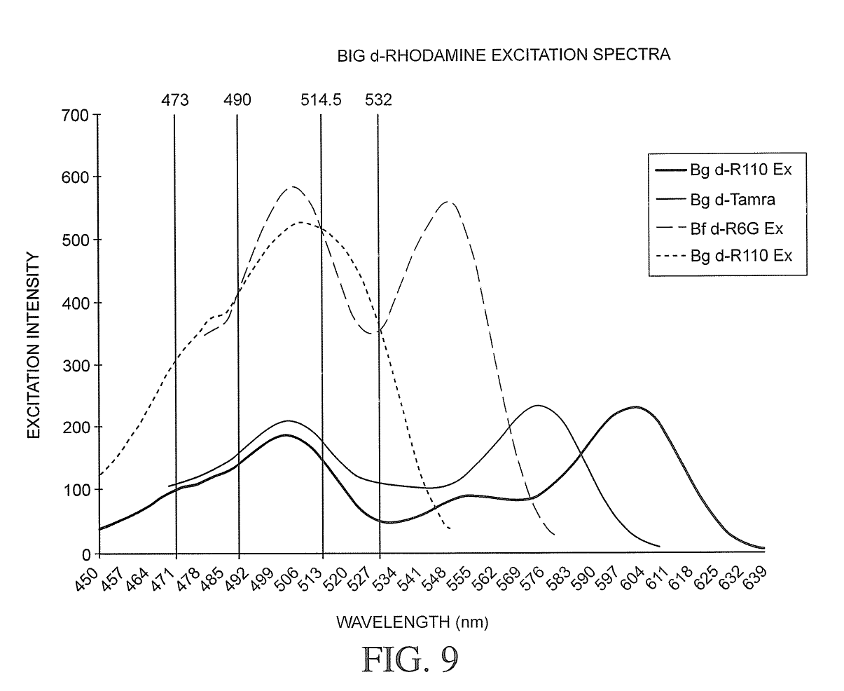

According to various embodiments, FIGS. 6-9 show the complete excitation spectra for various dyes. Included are spectra for a selection of energy transfer dyes (labelled “Big d-rhodamine”), fluorescein dyes, and d-rhodamine dyes.

According to various embodiments, FIGS. 10 and 11 show that, although the Stokes Shift for different dyes vary, it varies within a limited range.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the,” include plural referents unless expressly and unequivocally limited to one referent. Thus, for example, reference to “a light source” includes two or more different light sources. As used herein, the term “include” and its grammatical variants are intended to be non-limiting, such that recitation of items in a list is not to the exclusion of other like items that can be substituted or added to the listed items.

Various embodiments of the teachings are described herein. The teachings are not limited to the specific embodiments described, but encompass equivalent features and methods as known to one of ordinary skill in the art. Other embodiments will be apparent to those skilled in the art from consideration of the present specification and practice of the teachings disclosed herein. It is intended that the present specification and examples be considered as exemplary only.

What is claimed:

1.-2. (canceled)

3. A system for fluorescent detection, the system comprising:
a single-wavelength laser source, wherein the wavelength is from 505 nanometers to 510 nanometers.

4.-13. (canceled)

14. A system for fluorescent detection, the system comprising:
a single-wavelength laser source adapted to provide excitation to simple fluorescent dyes and energy transfer dyes, wherein the wavelength of excitation provides an effective Stoke's shift of at least 10 nanometers for simple fluorescent dyes and energy transfer dyes, wherein the wavelength is from 505 nanometers to 510 nanometers.

15. (canceled)

16. The system according to claim 3, wherein the laser is a solid state laser.

17.-23. (canceled)

24. (canceled)

25. The system according to claim 14, wherein the laser is a solid state laser.

26. The system according to claim 3, wherein the system provides sequence detection.

27. The system according to claim 3, further comprising a capillary electrophoresis assembly.

28. The system according to claim 3, wherein the system provides PCR detection.

29. The system according to claim 3, wherein the single-wavelength laser source is an array of laser sources each providing light at a single wavelength.

30. The system according to claim 3, wherein the system provides microarray hybridization detection.

31. The system according to claim 3, further comprising simple fluorescent dyes and energy transfer dyes.

32. (canceled)

33. The system according to claim 14, wherein the system provides sequence detection.

34. The system according to claim 14, further comprising a capillary electrophoresis assembly.

35. The system according to claim 14, wherein the system provides PCR detection.

36. The system according to claim 14, wherein the single-wavelength laser source is an array of laser sources each providing light at a single wavelength.

37. The system according to claim 14, wherein the system provides microarray hybridization detection.

38. (canceled)

39. A method for fluorescent detection, the method comprising:
providing a single-wavelength laser source, wherein the wavelength is from 505 nanometers to 510 nanometers;
exciting a plurality of dyes, wherein the dyes comprise simple fluorescent dyes and energy transfer dyes;
detecting fluorescent light from the plurality of dyes to provide information concerning a biological reaction.

40. The method of claim 39, wherein the biological reaction can be chosen from a sequencing reaction, PCR, and microarray hybridization.

41. The method of claim 39, wherein the fluorescent detection is done from a capillary electrophoresis assembly.
